(19) United States
(12) Patent Application Publication
(10) Pub. No.: US 2007/0175604 A1
(43) Pub. Date: Aug. 2, 2007

(54) Process for mixing, device therefor and use thereof

(75) Inventors: Berndt Cupak, Puchkirchen am Trattberg (AT); Anton Ortner, Vocklabruck (AT); Johann Grostlinger, Thomasroith (AT); Andreas Krotscheck, Lenzing (AT)

Correspondence Address: FITZPATRICK CELLA HARPER & SCINTO, 30 ROCKEFELLER PLAZA, NEW YORK, NY, 10112, US

(73) Assignee: Lenzing Technik Gmbh & Co KG

(21) Appl. No.: 11/655,645

(22) Filed: Jan. 19, 2007

Related U.S. Application Data
(63) Continuation of application No. PCT/AT05/00229, filed on Jun. 24, 2005.

(30) Foreign Application Priority Data
Jul. 21, 2004 (AT) A 1245/2004

(51) Int. Cl. B01F 7/00; B28C 7/04; B01F 3/12; D21B 1/34

(52) U.S. Cl. 162/57; 366/34; 366/37; 366/64; 366/184

(57) ABSTRACT

In a process for continuous blending and/or fluidization of a suspension or a pulp and/or for incorporation of gaseous and/or liquid media into a suspension or pulp, respectively, in particular into a suspension of a fibrous material with fluids, the suspension or pulp, respectively, is subjected to shear forces in a rotary mixer. So as to be able to effect blending or incorporation, respectively, of media into the suspension or pulp, respectively, in an efficient manner and, optionally, over an extended period of time, the suspension or pulp, respectively, is subjected to shear forces of varying sizes across the circumference of the rotary mixer (FIG. 2).

### CROSS REFERENCE TO RELATED APPLICATIONS

This application is a continuation of International Patent Application No. PCT/AT2005/000229 filed on Jun. 24, 2005, which claims priority to Austrian Patent Application No. A 1245/2004 filed on Jul. 21, 2004.

### FIELD OF THE INVENTION

The invention relates to a process for continuous blending and/or fluidization of a suspension or a pulp and/or for incorporation of gaseous and/or liquid media into a suspension or pulp, respectively, in particular into a suspension of a fibrous material with fluids, wherein the suspension or pulp, respectively, is subjected to shear forces of varying sizes in a rotary mixer across the circumference of said rotary mixer, as well as to a device for implementing the process and, furthermore, to a use of the device.

### BACKGROUND OF THE INVENTION

So as to bring suspensions from a viscous state into a readily flowable, so-to-speak highly fluid state, blending is necessary, especially for suspensions of chemical pulp and water. Only after said readily flowable state—also referred to as a fluidized state—of the suspension has been reached can the suspension be properly blended and, furthermore, be mixed with media which, for example, are chemicals which enter into a reaction with the suspension or which behave, respectively, in an inert manner relative to the suspension, such as, for example, a dye etc.

For this purpose, it is known to fluidize pulp between a rotating rotor disk comprising radial ribs which are arranged in a radiated manner and a stationary stator disk with ribs. Fluidization occurs exclusively in the emerging radial flow from the inside to the outside and is stopped upon reaching the exterior circumference of the rotor disk. In this manner, only short-term fluidization can be achieved particularly since the rotor and stator disks would have to take on extremely large diameters for fluidizations occurring over longer periods of time. This, in turn, would involve extremely high peripheral speeds and complex constructions.

Processes and means for fluidization are furthermore known from EP 0 664 150 A1 and U.S. Pat. No. 5,813,758 A. Both documents have means in which a rotor is arranged centrally in a stator, which rotor is equipped with drivers which enable fluidization of a suspension or, respectively, incorporation of a gas into a pulp. In doing so, the suspension or pulp, respectively, passes a very narrow gap between the stator and the rotor, with the gap being oriented in parallel to the rotor axis or inclined thereto or in a radial manner, respectively. Also according to these documents, it is not possible to keep a suspension or pulp, respectively, highly fluid over an extended period of time for the purpose of incorporating gases or liquid media. According to U.S. Pat. No. 5,813,758 A, the largely radial transport of the suspension from the central inflow to the outflow also leads to extremely large devices involving the disadvantages of high peripheral speeds which result therefrom.

A process of the initially described kind is known from U.S. Pat. No. 5,575,559 A, wherein the flow of a suspension or pulp, respectively, occurs vertically to the axis of the rotary mixer. This requires—if blending is to proceed over an extended period of time—a large diameter of the rotary mixer, which is disadvantageous because of the required space and high peripheral speeds.

From AT 372 992 B, a rotary mixer for suspensions and pulps, respectively, is known, wherein a rotor is arranged centrally in a stator, with rib-like projections being provided in a gap between a rotor with a polygonal cross-section and a stator. In this manner, a pulsation of a shear force acting upon the suspension is achieved, wherein, however, said pulsating shear force occurs in a state of being distributed evenly across the circumference.

The invention aims at avoiding said disadvantages and difficulties and has as its object to provide a process of the initially described kind and a device for optimal continuous blending and/or fluidization of a suspension or a pulp and/or for incorporation of gaseous and/or liquid media into a suspension or pulp, respectively, by means of which it is feasible to accomplish, with a small effort, the incorporation process and blending, respectively, in an efficient manner and, optionally, over an extended period of time. In doing so, oversized dimensions of the device serving for this purpose and inadmissibly high peripheral speeds, respectively, should in particular be avoided.

With a process of the initially described kind, said object of the invention is achieved in that the suspension or pulp, respectively, is moved, in addition, from the inlet to the outlet of the rotary mixer along the length or longitudinal axis thereof.

In case the main reaction with an admixed chemical takes place inside the rotary mixer, the assessment of the residence time of the suspension and hence of the reaction time is effected in that the volume of the rotary mixer, in particular the length thereof, is designed accordingly.

Of course, it is also possible to introduce a gaseous or liquid medium into the suspension, such as, for example, oxygen, by means of which a main reaction takes place only outside of the rotary mixer, whereby, as a result of appropriately dimensioning the volume of the rotary mixer, in particular the length thereof, the residence time of the suspension is determined such that a main reaction will take place outside of the rotary mixer.

Furthermore, it is possible to introduce an inert gaseous or liquid medium into the suspension, such as, for example, a dye with which no chemical reaction occurs.

### SUMMARY OF THE INVENTION

The process according to the invention allows broad applications, in particular for pulp suspensions with a stock consistency of between 4 and 20%, in particular of between 8 and 15%.

A device for blending a suspension or a pulp and/or for incorporation of gaseous and/or liquid media into a suspension or a pulp, in particular into a suspension of a fibrous material with fluids, comprising a stator and a rotor arranged on the stator so as to be rotatable around its axis, with the axis of the rotor being arranged so as to be offset relative to the axis of the stator, as well as comprising an inlet and an outlet opening for the suspension or pulp, respectively, is characterized in that the inlet opening is arranged at a distance from the outlet opening in the direction of the axis of the stator which is configured as a longitudinal axis.

The longitudinal axis of the rotor is preferably arranged in parallel to the longitudinal axis of the stator.

A preferred embodiment is characterized in that an eccentricity between the longitudinal axis of the stator and the longitudinal axis of the rotor lies in the range of from 1/200 to 1/2 of the inside diameter of the drum of the stator.

Furthermore, it is advantageous if the ratio of the outside diameter of the rotor to the inside diameter of the drum of the stator lies in the range of from 1:1.1 to 1:5, with the height of the flow breakers suitably lying in the range of between 1/50 and 1/1.4 of the outside diameter of the rotor.

A further preferred variant is characterized in that the width of the flow breakers lies in the range of between 1/100 and 10/1 of their height.

Preferably, flow breakers extending essentially transversely to the peripheral direction are provided on the stator and drivers extending essentially transversely to the peripheral direction are provided on the rotor, with the flow breakers and/or the drivers advantageously extending continuously across the length of the rotary mixer from the inlet opening to the outlet opening.

According to a preferred embodiment, at least some flow breakers and/or drivers extend only over partial sections of the length of the rotary mixer and are preferably arranged so as to be offset to each other in the peripheral direction.

The inlet nozzle and/or the outlet nozzle can be oriented radially to the longitudinal axis of the stator or also in the direction of the longitudinal axis of the stator. If a medium is added, a feeding pipe for the medium runs into the stator in the area of the inlet nozzle or, respectively, several medium inlet nozzles are arranged so as to be distributed across the length of the mixer.

According to a preferred variant, a gap is provided in a radial direction between the flow breakers of the stator and the drivers of the rotor, which gap lies, at its narrowest spot, in the range of from 0.02 to 80 and, at its widest spot, in the range of from 1 to 90, indicated, in each case, in percent of the inside diameter of the stator.

Using the device according to the invention is advantageous especially for the pulp industry such as for the production of multiphase mixtures primarily consisting of a suspension of pulp, water and chemicals (in a liquid, gaseous or solid state of matter) or for the production of a multiphase mixture of waste paper and water.

### BRIEF DESCRIPTION OF THE FIGURES

FIG. 1 shows a view of a rotary mixer.

FIG. 2 shows a section taken along line II-II of FIG. 1.

### DETAILED DESCRIPTION OF THE INVENTION

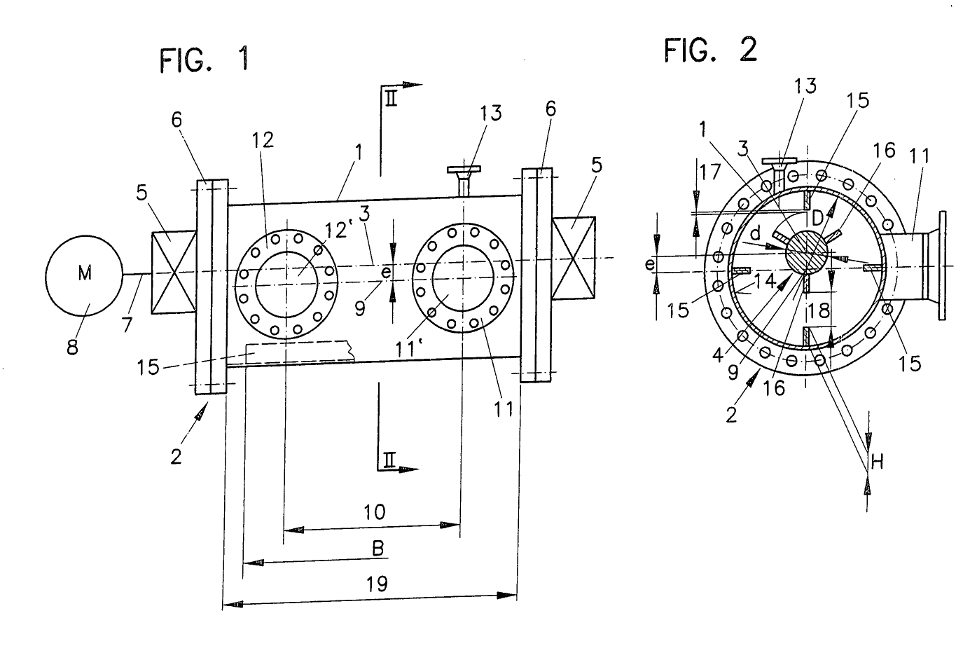

Below, the invention is explained in further detail by way of an exemplary embodiment illustrated in the drawings, with FIG. 1 showing a view of a rotary mixer. FIG. 2 shows a section taken along line II-II of FIG. 1.

In a drum 1 designed essentially cylindrically and serving as a stator 2 of a rotary mixer, a rotor 4 arranged so as to be rotatable around its longitudinal axis 3 is provided, with the bearing 5 thereof being arranged on walls 6 closing the drum 1 on the front side. A drive shaft 7 of the rotor 4 extends beyond a bearing 5 and can be actuated via a motor 8. The rotor 4 can also be designed as a unit mounted in a one-sided and floating manner.

An inlet nozzle 11 for a suspension or pulp, respectively, and an outlet nozzle 12 for the same are provided at a distance 10 from each other on the cylindrical drum 1 of the stator 2 in the direction of the longitudinal axis 9 of the stator 2. In the area of the inlet nozzle 11, a feeding pipe 13 for a medium to be added, e.g., a gas or a liquid, runs, if desired, into the interior of the stator 2.

The inlet and outlet openings 11′, 12′ for the suspension or pulp, respectively, and for chemicals 4 are arranged either radially on the stator 2 or in parallel to the longitudinal axis 3 of the rotor 4.

Flow breakers 15 extending essentially transversely to the peripheral direction of the drum 1 are arranged at the inside 14 of the drum 1 of the stator 2. The rotor 4, in turn, comprises drivers 16 extending essentially transversely to the peripheral direction.

The axis 3 of the rotor 4 is arranged eccentrically, by the measure e, relative to the axis 9 of the stator 2. During rotation of the rotor 4, a gap is thereby formed between the circle of rotation of the drivers 16 and the flow breakers 15, which gap has, at its narrowest spot 17, a thickness of from 0.02 to 80 and, at its widest spot 18, a thickness of from 1 to 90, indicated, in each case, in percent of the inside diameter D of the stator.

Neither the flow breakers 15 nor the drivers 16 have to extend continuously in one piece across the entire length 19 of the rotary mixer, i.e., the drum 1 thereof; they can be formed from several successively arranged parts which, optionally, are also arranged so as to be offset to each other in the peripheral direction of the rotor 4 or in the peripheral direction of the stator 2, respectively.

Advantageously, the width B of the flow breakers 15 lies in the range of between 1/100 and 10/1 of their height H.

The number and geometry of the flow breakers and drivers, respectively, on the rotor and on the stator can be chosen freely.

For proper incorporation, especially of a gas, into a suspension of chemical pulp and water it has proven to be suitable if the ratio of the outside diameter d of the rotor 4 to the inside diameter D of the drum 1 of the stator 2 lies in the range of from 1:1.1 to 1:5, with the height H of the flow breakers 15 advantageously lying in the range of between 1/50 and 1/1.4 of the outside diameter d of the rotor 4.

The drivers 16 and flow breakers 15 can be provided in freely selectable numbers and in various embodiments. The function of the rotary mixer is largely independent of the position and number of drivers 16 and flow breakers 15 as illustrated in FIG. 2, of the geometry ratios of the rotor 4 and the stator 2, of the arrangement and number of inlet and outlet nozzles 11, 12 for media, of the mixer length 19 as well as the size of the eccentricity between the rotor axis and the stator axis.

The eccentric arrangement of the rotor 4 and the axial flow of the suspension or pulp, respectively, is characteristic of the invention.

In this way, the suspension or pulp, respectively, between the drivers 16 on the rotor 4 and the flow breakers 15 on the stator 2 is exposed to shear forces of varying strengths due to the high peripheral speed and the varying cross-sections which result from the rotation, whereby the suspension or pulp, respectively, very quickly changes into a state in which, in terms of fluidics, it behaves like water and thus becomes pumpable or, respectively, an efficient incorporation of fluids, especially of gases, is rendered possible.

What is advantageous about the mixing principle according to the invention is not only that the above-described state is quickly achieved but, furthermore, also that said fluidized state is maintained over a period of time which can be chosen arbitrarily via the mixer volume and/or the mixer length, respectively. Conventional mixers achieve residence times in the fluidized state of merely a few tenths of a second.

A further characteristic is the very efficient incorporation, that is, especially when admixing gases, a very homogeneous, fine-pored dispersion is achieved which brings the gaseous chemicals in a finely distributed state directly to the fibers of the suspension and renders possible there the reaction with the fiber material.

A specific application of the rotary mixer is provided primarily for fiber suspensions, for example, chemical pulp with a stock consistency of from 4 to 20% comprising other fluids (bleaching chemicals), e.g., H2O2, ClO2, NaOH, O3, O2, Cl, N etc., as well as, furthermore, for mass-transfer-limited reactions for the production of viscoses and mashes, respectively, by incorporation of solvents and/or curing substances, respectively.

Specific Applications are Described Herein Below:

Ozone Bleaching Stage:

Via a medium consistency pump, pulp is conveyed to the rotary mixer under a pressure of 1 to 20 bar overpressure. In the area of the material inflow, also the ozone gas is metered into the rotary mixer. In the rotary mixer, the pulp is fluidized very quickly and, simultaneously, the ozone gas is added to the pulp suspension in a very homogeneous and fine-pored state. The main reaction takes place in the fluidized state, whereby the ozone gas, in the form of small bubbles, gets directly to the fiber and the bleaching reaction occurs there. As a result of the significantly longer residence times, a far better reaction is achieved already in the rotary mixer. Due to the more efficient incorporation of the ozone gas and the production of a very homogeneous and fine-pored dispersion, also the chemical reaction after the rotary mixer is more efficient than with conventional mixing principles. That is, with smaller ozone inputs, a higher ozone conversion is achieved. Finally, the ozone gas that has largely completed its reaction is separated from the pulp suspension via a degassing vessel.

Oxygen Bleaching:

Pulp is conveyed to the rotary mixer with a pressure of 3 to 20 bar overpressure. In the area of the material inflow, also the oxygen gas is metered into the rotary mixer. In the rotary mixer, the pulp is fluidized very quickly and, simultaneously, the oxygen gas is added to the pulp suspension in a very homogeneous and fine-pored state. The main reaction takes place in the subsequent reactor with a relatively long residence time of up to two hours. Due to the more efficient incorporation of the oxygen gas and the production of a very homogeneous and fine-pored dispersion, a higher delignification rate than with previous mixing principles is achieved in the reactor, with the residence time remaining unchanged.

Incorporation of Liquid Bleaching Components:

The mixing principle is also perfectly suitable for incorporation of liquid chemicals such as, e.g., chloride oxide or hydrogen peroxide into a pulp suspension of medium consistency. In these applications, a shorter mixer length can be chosen in order to reduce the current consumption, since, in this case, primarily the efficient incorporation rather than the increased residence time has an effect in the fluidized state.

What is claimed is:

1. A process for continuous blending and/or fluidization of a suspension or a pulp and/or for incorporation of gaseous and/or liquid media into a suspension or pulp, respectively, in particular into a suspension of a fibrous material with fluids, using a rotary mixer, wherein the suspension or pulp, respectively, is moved, in addition, from the inlet to the outlet of the rotary mixer along the length or longitudinal axis thereof, characterized in that the suspension or pulp, respectively, is subjected to shear forces of varying sizes in the rotary mixer across the circumference of said rotary mixer, namely in that the flow of the suspension or pulp, respectively, is broken by flow breakers in the peripheral direction on the stator, as a result of a gap between the rotor and the flow breakers which has a varying size across the circumference.

2. A process according to claim 1, characterized in that a gaseous or liquid chemical such as, for example, ozone gas is admixed into a suspension of a fibrous material with fluids and that, by appropriately dimensioning the volume of the rotary mixer, in particular the length (19) thereof, the residence time of the suspension and hence the reaction time are determined such that a main reaction with the chemical will take place inside the rotary mixer.

3. A process according to claim 1 or 2, characterized in that a gaseous or liquid medium such as, for example, oxygen is admixed into a suspension of a fibrous material with fluids, wherein, by appropriately dimensioning the volume of the rotary mixer, in particular the length (19) thereof, the residence time of the suspension is determined such that a main reaction will take place outside of the rotary mixer.

4. A process according to claim 1, 2 or 3, characterized in that a gaseous or liquid medium such as, for example, a dye is admixed into a suspension of a fibrous material with fluids, with the medium being inert relative to the suspension.

5. A process according to claims 1 to 4, characterized in that a pulp suspension with a stock consistency of from 4 to 20%, in particular from 8 to 15%, is mixed with gaseous and/or liquid chemicals.

6. A device for blending a suspension or a pulp and/or for incorporation of gaseous and/or liquid media into a suspension or a pulp, in particular into a suspension of a fibrous material with fluids, comprising a stator (2) and a rotor (4) arranged on the stator so as to be rotatable around its axis (3), with the axis (3) of the rotor (4) being arranged so as to be offset relative to the axis (9) of the stator (2), as well as comprising an inlet and an outlet opening (11′, 12′) for the suspension or pulp, respectively, and with the inlet opening (11′) being arranged at a distance from the outlet opening (12′) in the direction of the axis of the stator (2) which is configured as a longitudinal axis (9), characterized in that flow breakers (15) extending essentially transversely to the peripheral direction are provided on the stator (2) and drivers (16) extending essentially transversely to the peripheral direction are provided on the rotor (4).

7. A device according to claim 6, characterized in that the longitudinal axis (3) of the rotor (4) is arranged in parallel to the longitudinal axis (9) of the stator (2).

8. A device according to claim 7, characterized in that an eccentricity (e) between the longitudinal axis (9) of the stator (2) and the longitudinal axis (3) of the rotor (4) lies in the range of from 1/200 to 1/2 of the inside diameter (D) of the drum (1) of the stator (2).

9. A device according to one or several of claims 6 to 8, characterized in that the ratio of the outside diameter (d) of the rotor (4) to the inside diameter (D) of the drum (1) of the stator (2) lies in the range of from 1:1.1 to 1:5.

10. A device according to one or several of claims 6 to 9, characterized in that the height (H) of the flow breakers (15) lies in the range of between 1/50 and 1/1.4 of the outside diameter (d) of the rotor (4).

11. A device according to one or several of claims 6 to 10, characterized in that the width (B) of the flow breakers (15) lies in the range of between 1/100 and 10/1 of their height (H).

12. A device according to one or several of claims 6 to 11, characterized in that the flow breakers (15) and/or the drivers (16) extend continuously across the length (19) of the rotary mixer from the inlet opening (14) to the outlet opening (15).

13. A device according to one or several of claims 6 to 12, characterized in that at least some flow breakers (15) and/or drivers (16) extend only over partial sections of the length (19) of the rotary mixer and are preferably arranged so as to be offset to each other in the peripheral direction.

14. A device according to one or several of claims 6 to 13, characterized in that the inlet opening (14) and/or the outlet opening is/are oriented radially to the longitudinal axis (9) of the stator (2).

15. A device according to one or several of claims 6 to 14, characterized in that the inlet opening (14) and/or the outlet opening is/are oriented in the direction of the longitudinal axis (9) of the stator (2).

16. A device according to one or several of claims 6 to 15, characterized in that, in the area of the inlet opening (14), a feeding pipe (13) for a gas or a liquid runs into the stator (2).

17. A device according to one or several of claims 6 to 16, characterized in that a gap is provided in a radial direction between the flow breakers (15) of the stator (2) and the drivers (16) of the rotor (4), which gap lies, at its narrowest spot (17), in the range of from 0.02 to 80 and, at its widest spot (18), in the range of from 1 to 90, indicated, in each case, in percent of the inside diameter (D) of the stator (2).

18. The use of a device according to one or several of claims 6 to 17 in the pulp industry, in particular for the production of multiphase mixtures primarily consisting of a suspension of pulp, water and chemicals in a liquid, gaseous or solid state of matter.

19. The use according to claim 18, in the paper industry, in particular for the production of a multiphase mixture of waste paper and water.
